(19) United States
(12) Patent Application Publication
(10) Pub. No.: US 2006/0037948 A1
(43) Pub. Date: Feb. 23, 2006

(54) Laser can opener apparatus

(76) Inventor: Steven L. Adams, Leander, TX (US)

Correspondence Address: S. Michael Bender, P.O. Box 530399, St. Petersburg, FL, 33747, US

(21) Appl. No.: 10/919,637

(22) Filed: Aug. 17, 2004

(51) Int. Cl. B23K 26/38

(52) U.S. Cl. 219/121.67

(57) ABSTRACT

A laser can opener apparatus includes a housing assembly which includes a main housing portion and an access door connected to the main housing portion. The main housing portion defines a can-reception/cutting space. A cutting laser assembly is supported by the main housing portion. An electrical power supply, supported by the main housing portion and electrically connected to the cutting laser assembly, is provided for powering the cutting laser assembly. A control assembly/circuitry has a keypad, display, and computer processor and is provided for controlling the cutting laser assembly. The cutting laser assembly can include a carriage track unit and a laser carriage unit which rides in the carriage track unit under computer control. With one embodiment, the cutting laser assembly is mounted on a ceiling portion of the main housing portion. With another embodiment, the cutting laser assembly is mounted on a sidewall portion of the main housing portion.

### BACKGROUND OF THE INVENTION

1. Field of the Invention

The present invention relates generally to devices for cutting metal with a laser, and, more particularly, to a device especially adapted for cutting off the lid of a metal can using a laser.

2. Description of the Prior Art

It is well known in the art to use a laser beam for cutting metal. The precision of the laser beam and the intense heat of the laser beam have been used in a number of innovations for cutting metal, and the following U.S. patents are representative of some of those innovations: U.S. Pat. Nos. 4,434,349, 5,468,247, and 5,755,035. More specifically, U.S. Pat. No. 4,434,349 discloses a machine that employs a laser beam for cutting metal. U.S. Pat. No. 5,468,247 discloses that a laser is employed for cutting a blade. U.S. Pat. No. 5,755,035 discloses that in the manufacture of a knife, a laser cutter is employed. It is noted that there is no disclosure in these cited patents that a laser is employed for cutting the lid of a can, such as a can containing a food product, so that the cut can lid can be removed from the remainder of the can to allow dispensing of the canned product. In this respect, it would be desirable if an apparatus were provided that employs a laser for cutting the lid off of a can containing a canned product so that the cutoff can lid can be removed from the remainder of the can to allow dispensing of the canned product.

The following U.S. patents may be of interest for their disclosure of substantially conventional can openers: U.S. Pat. Nos. 4,028,805 and 5,347,720. More specifically, U.S. Pat. No. 4,028,805 discloses a can opener that mechanically cuts out a can lid from above the can. In contrast, U.S. Pat. No. 5,347,720 discloses a can opener in which a cutting wheel is used to cut off the top of a can from the side of the can. In this respect, it would be desirable if a can opener were provided which permits a laser to cut the lid off of a can either from above the can or from the side of the can.

It is also noted that in U.S. Pat. No. 5,347,720, once a lid is cut mechanically by a cutting wheel, a laser beam may be used to bend the side of the can to facilitate removal of the already-cut lid. In this instance, the laser beam is not used for cutting at all.

Still other features would be desirable in a laser can opener apparatus. For example, it would be desirable if a laser can opener apparatus included an exterior housing to shield persons from a laser cutting operation which takes place inside the housing. In addition, it would be desirable is a laser can opener apparatus included a sensor for locating and measuring the can so that the laser beam can be precisely aimed at the can for cutting the can lid.

Optionally, it would be desirable if a laser can opener apparatus could be programmed to make a variety of cuts, such as cutting two opposing triangular cuts on top of a juice can.

Another optional feature that would be desirable would be to provide a bar code reader and circuit which would match the type of laser cut to the product in the can, based on a scan of the bar code on the product. Then, preprogrammed cutting instructions would be carried out for the specific type of product and size of packaging.

Thus, while the foregoing body of prior art indicates it to be well known to use lasers for cutting metal and it is well known to have can openers, the prior art described above does not teach or suggest a laser can opener apparatus which has the following combination of desirable features: (1) employs a laser for cutting the lid off of a can containing a canned product so that the cut off can lid can be removed from the remainder of the can to allow dispensing of the canned product; (2) provides a can opener which permits a laser to cut the lid off of a can either from above the can or from the side of the can; (3) includes an exterior housing to shield persons from a laser cutting operation which takes place inside the housing; (4) includes a sensor for locating and measuring the can so that the laser beam can be precisely aimed at the can for cutting the can lid; and (5) can be programmed to make a variety of cuts, such as cutting two opposing triangular cuts on top of a juice can.

The foregoing desired characteristics are provided by the unique laser can opener apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a laser can opener apparatus which includes a housing assembly which includes a main housing portion and an access door connected to the main housing portion. The main housing portion defines a can-reception/cutting space. A cutting laser assembly is supported by the main housing portion. An electrical power supply, supported by the main housing portion and electrically connected to the cutting laser assembly, is provided for powering the cutting laser assembly. A control assembly/circuitry, supported by the main housing portion and electrically connected between the electrical power supply and the cutting laser assembly, is provided for controlling the cutting laser assembly. The access door includes a door handle.

Preferably, the control assembly/circuitry includes a keypad, a display, and a computer processor electrically connected to the keypad and to the display. The computer processor is controlled by the keypad and controls the cutting laser assembly.

Preferably, the control assembly/circuitry further includes a can sensor assembly, supported by the main housing portion and electrically connected to the computer processor, for sensing the presence of a can inside the can-reception/cutting space and for signalling the computer processor for controlling the cutting laser assembly.

The cutting laser assembly can include a carriage track unit supported by the main housing portion and can include a laser carriage unit supported by the carriage track unit.

Preferably, a rotatable platform assembly is supported by a floor portion of the main housing portion. The rotatable platform assembly includes a rotatable platform member and includes a rotation drive assembly supported by the floor portion.

With one embodiment, the cutting laser assembly is mounted on a ceiling portion of the main housing portion. With another embodiment, the cutting laser assembly is mounted on a sidewall portion of the main housing portion.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved laser can opener apparatus which has all of the advantages of the prior art and none of the disadvantages.

It is another object of the present invention to provide a new and improved laser can opener apparatus which may be easily and efficiently manufactured and marketed.

It is a further object of the present invention to provide a new and improved laser can opener apparatus which is of durable and reliable construction.

An even further object of the present invention is to provide a new and improved laser can opener apparatus which is susceptible of a low cost of manufacture with regard to both materials and labor, and which accordingly is then susceptible of low prices of sale to the consuming public, thereby making such laser can opener apparatus available to the buying public.

Still yet a further object of the present invention is to provide a new and improved laser can opener apparatus which employs a laser for cutting the lid off of a can containing a canned product so that the cut off can lid can be removed from the remainder of the can to allow dispensing of the canned product.

Still another object of the present invention is to provide a new and improved laser can opener apparatus that provides a can opener which permits a laser to cut the lid off of a can either from above the can or from the side of the can.

Yet another object of the present invention is to provide a new and improved laser can opener apparatus which includes an exterior housing to shield persons from a laser cutting operation which takes place inside the housing.

Even another object of the present invention is to provide a new and improved laser can opener apparatus that includes a sensor for locating and measuring the can so that the laser beam can be precisely aimed at the can for cutting the can lid.

Still a further object of the present invention is to provide a new and improved laser can opener apparatus which can be programmed to make a variety of decorative cuts, such as cutting two opposing triangular cuts on top of a juice can.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the laser can opener apparatus of the invention, wherein the access door is closed, and wherein the cutting laser assembly is supported from an ceiling portion of the apparatus.

FIG. 2 is a top view of the embodiment of the laser can opener apparatus shown in FIG. 1 taken along line 2-2 of FIG. 1, wherein the access door is shown partially open in broken lines.

FIG. 3 is a cross-sectional view of the embodiment of the laser can opener apparatus of FIG. 1 taken along line 3-3 thereof, wherein a can is shown inside the apparatus.

FIG. 4 is a cross-sectional view of the embodiment of the invention shown in FIG. 3, taken along line 4-4, wherein the can is removed.

FIG. 5 is a cross-sectional view of a second embodiment of the invention, wherein the cutting laser assembly is supported on as side wall portion of the apparatus.

FIG. 6 is a block diagram illustrating the interrelationships of the major sub-units of either preferred embodiment of the invention.

### DESCRIPTION OF THE PREFERRED EMBODIMENT

With reference to the drawings, a new and improved laser can opener apparatus embodying the principles and concepts of the present invention will be described.

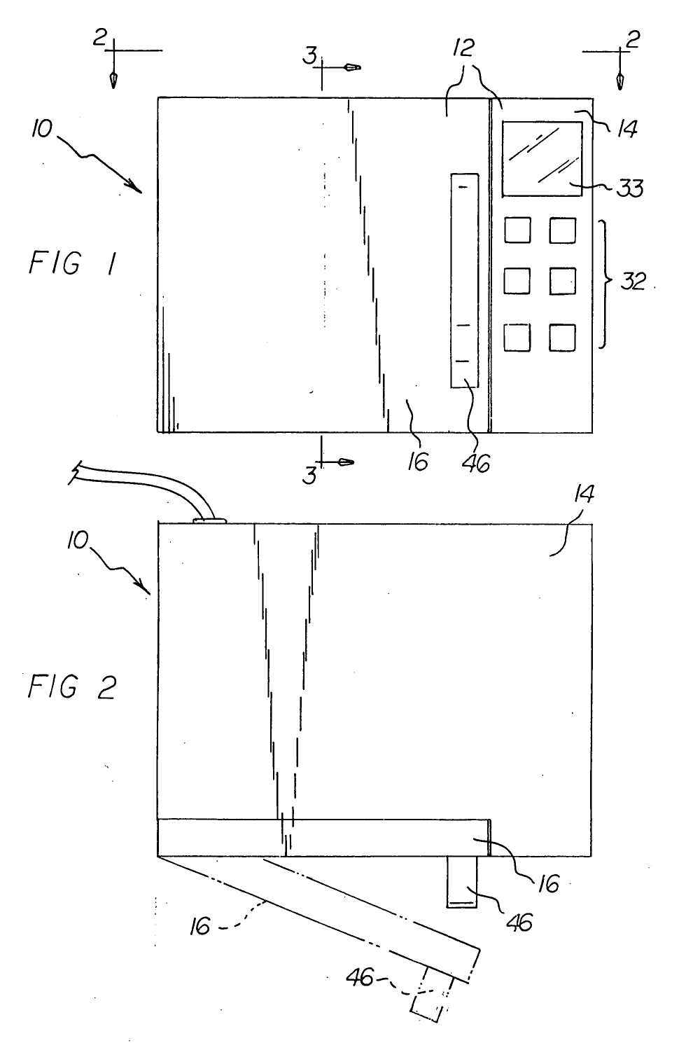

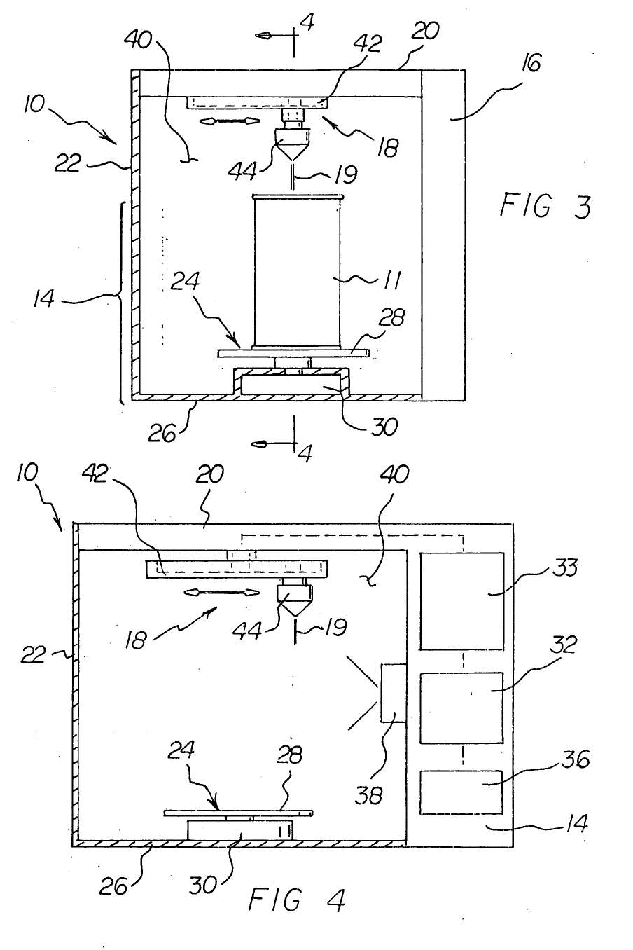

Turning to FIGS. 1-4, there is shown a first embodiment of the laser can opener apparatus of the invention generally designated by reference numeral 10. In the first embodiment, laser can opener apparatus 10 includes a housing assembly 12 which includes a main housing portion 14 and an access door 16 connected to the main housing portion 14. The main housing portion 14 defines a can-reception/cutting space 40. A cutting laser assembly 18 is supported by the main housing portion 14. An electrical power supply 36, supported by the main housing portion 14 and electrically connected to the cutting laser assembly 18, is provided for powering the cutting laser assembly 18. A control assembly/circuitry 35, supported by the main housing portion 14 and electrically connected between the electrical power supply 36 and the cutting laser assembly 18, is provided for controlling the cutting laser assembly 18. The access door 16 includes a door handle 46.

Preferably, the control assembly/circuitry 35 includes a keypad 32, a display 33, and a computer processor 34 electrically connected to the keypad 32 and to the display 33. The computer processor 34 is controlled by the keypad 32 and controls the cutting laser assembly 18.

Preferably, the control assembly/circuitry 35 further includes a can sensor assembly 38, supported by the main housing portion 14 and electrically connected to the computer processor 34, for sensing the presence of a can 11 inside the can-reception/cutting space 40 and for signalling the computer processor 34 for controlling the cutting laser assembly 18.

The cutting laser assembly 18 can include a carriage track unit 42 supported by the main housing portion 14 and can include a laser carriage unit 44 supported by the carriage track unit 42.

Preferably, a rotatable platform assembly 24 is supported by a floor portion 26 of the main housing portion 14. The rotatable platform assembly 24 includes a rotatable platform member 28 and includes a rotation drive assembly 30 supported by the floor portion 26.

With the embodiment of the invention shown in FIGS. 1-4, the cutting laser assembly 18 is mounted on a ceiling portion 20 of the main housing portion 14.

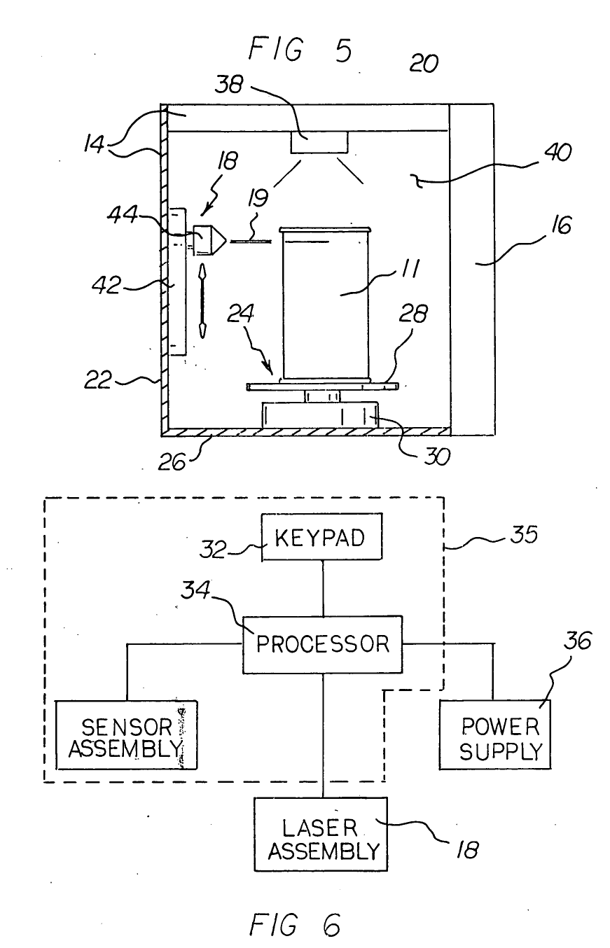

In contrast, with the second embodiment of the invention shown in FIG. 5, the cutting laser assembly 18 is mounted on a sidewall portion 22 of the main housing portion 14.

To use either embodiment of the invention, the access door 16 is opened, and a can 11 is placed on the rotatable platform member 28. Then, the access door 16 is closed. The user makes entries on the keypad 32. Entries on the keypad 32 can be visualized in the display 33. The entries on the keypad 32 determine the size and shape of the cutting of the can 11 by the cutting laser assembly 18 under the control of the computer processor 34.

In addition, the can sensor assembly 38 can sense the location of the can 11 to be opened within the can-reception/cutting space 40 in relation to the cutting laser assembly 18. The can sensor assembly 38 can measure the dimensions of the can 11 needed for a correct cut and cause the cutting laser assembly 18 to be positioned correctly.

When the laser cutting is about to begin, the rotation drive assembly 30 causes the rotatable platform member 28 and the can 11 thereon to rotate. Then, under the control of the computer processor 34, the laser carriage unit 44 is caused to emit the cutting laser beam 19. That is, the cutting laser beam 19 is directed to the can 11. As the can 11 is rotated on the rotatable platform member 28, the laser carriage unit 44 can be caused to remain stationary, or, alternatively to be translated along the carriage track unit 42. The combined movement of the can 11 on the rotatable platform member 28 and the laser carriage unit 44 on the carriage track unit 42 can provide virtually any programmed two-dimensional laser cut on the can 11.

For example, a simple circular cut can be employed to cut off the top of the can 11. Also, for example, the apparatus could be programmed to make two opposing triangular cuts on top of a juice can. Thus, it will be appreciated that a wide range of decorative cuts or cuts having a fanciful shape may be made in or on the can 11 can using the apparatus of the present invention.

If desired, an audible or visible alarm can be provided to alert the user when the cutting operation has been completed.

Preferably, the laser can opener apparatus of the invention can be in the form of a self-contained “box” that can typically rest upon a kitchen counter top. Such a “box” would resemble a small microwave oven with a door that would be completely sealed to prevent interior energy/radiation from leaking out from the can-reception/cutting space 40.

An additional benefit provided with a laser cut of the invention is the provision of a “smooth cut” to round the edges of the cut portions of the can 11 to prevent the user from cutting one's fingers.

Another optional feature would be to provide a bar code reader and circuit which would match the type of laser cut to the product in the can, based on a scan of the bar code on the product. Then, preprogrammed cutting instructions would be carried out for the specific type of product and size of packaging.

The type of laser that is employed does not spoil food by sending a radiation beam into the food. It is noted that by using the embodiment of the invention shown in FIG. 5, the cutting laser assembly 18 is mounted on a sidewall portion 22 of the main housing portion 14, the cutting laser beam 19 would not enter the food at all or enter the food in only a minimal way.

The components of the laser can opener apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved laser can opener apparatus that is low in cost, relatively simple in design and operation, and which may advantageously be used to employ a laser for cutting the lid off of a can containing a canned product so that the cut off can lid can be removed from the remainder of the can to allow dispensing of the canned product. With the invention, a laser can opener apparatus provides a can opener which permits a laser to cut the lid off of a can either from above the can or from the side of the can. With the invention, a laser can opener apparatus is provided which includes an exterior housing to shield persons from a laser cutting operation which takes place inside the housing. With the invention, a laser can opener apparatus is provided which includes a sensor for locating and measuring the can so that the laser beam can be precisely aimed at the can for cutting the can lid. With the invention, a laser can opener apparatus is provided which can be programmed to make a variety of decorative cuts, such as cutting two opposing triangular cuts on top of a juice can.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. For example, the apparatus of the invention may be used to cut into packages or containers of materials other than metal, i.e. other than cans, such as cardboard or plastic.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A laser apparatus for opening a container, comprising:
a housing assembly which includes main housing portion and an access door connected to said main housing portion, wherein said main housing portion defines a can-reception/cutting space,
a cutting laser assembly supported by said main housing portion,
an electrical power supply, supported by said main housing portion and electrically connected to said cutting laser assembly, for powering said cutting laser assembly, and
a control assembly/circuitry, supported by said main housing portion and electrically connected between said electrical power supply and said cutting laser assembly, for controlling said cutting laser assembly.

2. The apparatus of claim 1 wherein said access door includes a door handle.

3. The apparatus of claim 1 wherein said control assembly/circuitry includes:
a keypad,
a display, and
a computer processor electrically connected to said keypad and to said display, wherein said computer processor is controlled by said keypad and controls said cutting laser assembly.

4. The apparatus of claim 3 wherein said control assembly/circuitry further includes:
a container sensor assembly, supported by said main housing portion and electrically connected to said computer processor, wherein said container sensor assembly senses the presence of a can inside said can-reception/cutting space and signals said computer processor for controlling said cutting laser assembly.

5. The apparatus of claim 1 wherein said cutting laser assembly includes:
a carriage track unit supported by said main housing portion, and
a laser carriage unit supported by said carriage track unit.

6. The apparatus of claim 1, further including:
a rotatable platform assembly supported by a floor portion of said main housing portion.

7. The apparatus of claim 6 wherein said rotatable platform assembly includes:
a rotatable platform member, and
a rotation drive assembly supported by said floor portion.

8. The apparatus of claim 1 wherein said cutting laser assembly is mounted on a ceiling portion of said main housing portion.

9. The apparatus of claim 1 wherein said cutting laser assembly is mounted on a sidewall portion of said main housing portion.

10. The apparatus of claim 1 wherein said container is a metal can.

11. The apparatus of claim 1 wherein said container is made of a non-metal material.
